(19) United States
(12) Patent Application Publication
(10) Pub. No.: US 2004/0014923 A1
(43) Pub. Date: Jan. 22, 2004

(54) Silicone peroxides

(75) Inventors: Jochen Dauth, Burghausen (DE); Wolfgang Keller, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 10/447,519

(22) Filed: May 29, 2003

(30) Foreign Application Priority Data
Jul. 19, 2002 (DE) 102 32 995.8

(51) Int. Cl. C08G 77/00

(52) U.S. Cl. 528/10

(57) ABSTRACT

Peroxide-functional organopolysiloxanes (P) have at least one unit of the formula (I)

YₐR_{b}SiO_{4-a-b/2} (I)

where

Y is a group of the general formula (II)

-A-CR″₂—OO—R′″ (II)

wherein preferably, R is H or a hydrocarbon radical, A is a covalent bond or a divalent hydrocarbon radical, R″ is a hydrocarbon radical, R″ is H or a hydrocarbon radical, a is 1, 2, or 3, b is 0, 1, or 2, and the sum a+b is 1, 2, or 3.

### SUMMARY OF THE INVENTION

1. Field of the Invention

The invention relates to peroxide-functional organopolysilozanes.

2. Background Art

JP 2001081187 A2 describes the reaction of siloxanes having silicon-bound acid chlorides with low molecular weight tertiary organic hydroperoxides to give the corresponding peroxyester siloxanes. In the process described therein, the organic molecule is initially peroxidized, not the silicone moiety. The low molecular weight hydroperoxides are very difficult to handle; for example, they must be transported only under extreme safety measures and tend to decompose.

### SUMMARY OF THE INVENTION

The invention pertains to unique silicone peroxides prepared without the use of organic hydroperoxides, by reaction of a hydroxyalkyl- or alkenyl-functional organosilicon compound with hydrogen peroxide.

### DETAILED DESCRIPTION OF THE PREFERRED EMBODIMENT(S)

The invention provides a peroxide-functional organopolysiloxane (P) which has at least one unit of the general formula (I)

YₐR_{b}SiO_{4-a-b/2} (I)

where

Y is a group of the general formula (II)

-A-CR″₂—OO—R′″ (II),

R is a hydrogen atom, a C₁- to C₁₂-alkoxy, hydroxy or alkyl glycol radical or a monovalent, optionally cyano-, fluorine-, chlorine- or bromine-substituted C₁- to C₁₈-hydrocarbon radical which may be interrupted by divalent radicals bonded on both sides to carbon atoms, from the group of —O—, —COO—, —OOC—, —CONR¹—, —NR¹CO— and —CO—,

A is a chemical bond or a divalent, optionally cyano-, fluorine-, chlorine- or bromine-substituted C₁- to C₁₈-hydrocarbon radical,

R″ is an optionally cyano-, fluorine-, chlorine- or bromine-substituted C₁- to C₁₀-hydrocarbon radical,

R′″ is a hydrogen atom, a monovalent C₁- to C₁₈-hydrocarbon radical or C₁- to C₁₈-acyl radical which may be cyano-, fluorine-, chlorine-, bromine- or organopolysiloxane-substituted, and may be interrupted by divalent radicals bonded on both sides to carbon atoms, from the group of —O—, —COO—, —OOC—, —CONR′—, —NR¹CO— and —CO—,

R¹ is a hydrogen atom or an R″ radical,

a is 1, 2 or 3,

b is 0, 1 or 2 and

the sum of a+b is 1, 2 or 3.

The peroxide-functional organopolysiloxane (P) may decompose in a defined manner, for example thermally or by redox reaction, to generate a silicone macroinitiator.

The organopolysiloxane (P) can be used to modify organopolysiloxanes (M). For example, use of organopolysiloxanes allow silicone constituents to be directly polymerized into polymers, e.g. into free-radically crosslinkable silicone rubbers, via the organopolysiloxane (P). The silicone rubbers can then be free-radically crosslinked using organopolysiloxane (P), for example using vinyl groups bound to the silicone rubber, as when preparing HTV silicone rubber.

The organopolysiloxane (P) can also be used as a free radical initiator in the synthesis of silicone block and graft copolymers by polymerization with monomers.

On redox induced decomposition of organopolysiloxanes (P), in which R′″ is a hydrogen atom (hydroperoxide) a polymer radical is formed, but an OH anion is generated rather than a low molecular weight radical. The OH radical which would ordinarily be expected as an intermediate is apparently converted so rapidly to an OH anion that it can form no homopolymeric by-products in a free radical polymerization. The organopolysiloxane hydroperoxide (P) is therefore particularly suitable as an initiator for copolymerizations which are carried out at temperatures below the critical decomposition temperature of the organopolysiloxane hydroperoxide (P) (approximately 90° C.). The organopolysiloxane hydroperoxide (P) therefore copolymerizes in redox polymerization with monomers to give block or graft copolymers without troublesome formation of homopolymers of the monomer.

Organopolysiloxane (P) can be prepared by a simple, problem-free and direct route with the aid of starting materials which are easy to handle.

In the organopolysiloxane (P) the peroxide groups are less reactive than low molecular weight peroxides. The peroxide content in the organopolysiloxane (P) can be adjusted as desired and can be lowered by addition of further siloxane units such that no solvent is required for dilution.

Examples of unsubstituted R and R′″ radicals include alkyl radicals such as the methyl and ethyl radicals; cycloalkyl radicals such as the cyclohexyl radical; aryl radicals such as the phenyl, biphenylyl, naphthyl, anthryl and phenanthryl radicals; alkaryl radicals such as the o-, m- and p-tolyl radicals, xylyl radicals and ethylphenyl radicals; and aralkyl radicals such as the benzyl radical and the alpha- and β-phenylethyl radicals.

Examples of substituted hydrocarbon radicals as R and R′″ radicals include halogenated hydrocarbon radicals; epoxyalkyl radicals; (meth)acryloxyalkyl radicals, cyanoalkyl radicals; aminoalkyl radicals; aminoaryl radicals; quaternary ammonium radicals; and hydroxyalkyl radicals. The alkoxy radicals R may be alkyl radicals such as those described above, bonded via an oxygen atom. The examples of alkyl radicals R also apply fully for the alkoxy radicals.

The R radical is preferably an unsubstituted or substituted C₁- to C₁₈-alkyl radical, hydrogen or the phenyl radical, in particular the methyl, ethyl, propyl, octyl, hexyl, dodecyl, octadecyl, phenyl, vinyl, allyl, methacryloxypropyl, 3-chloropropyl, 3-mercaptopropyl, 3-hydroxypropyl, 3-(2,3-dihydroxypropoxy)propyl, 3-aminopropyl and (2-aminoethyl)-3-aminopropyl radical, hydrogen, or a quaternary ammonium radical.

The R′″ radical is preferably hydrogen, an unsubstituted or substituted C₁- to C₁₈-alkyl radical, in particular a tert-butyl, isopropyl, octyl, hexyl, dodecyl or octadecyl radical.

The R″ radical is preferably an unsubstituted or substituted C₁- to C₆-alkyl radical, in particular the methyl, ethyl, or propyl radical.

Examples of divalent hydrocarbon radicals A include saturated alkylene radicals such as the methylene and ethylene radical, and also propylene, butylene, pentylene, hexylene, cyclohexylene and octadecylene radicals or unsaturated alkylene or arylene radicals such as the hexenylene radical and phenylene radicals, in particular linear C₁- to C₆-alkylene radicals, more preferably the ethylene radical.

In addition to the units of the general formula (I), the organopolysiloxane (P) may have further siloxane units, preferably those of the general formulae (III), (IV), (V) and (VI)

[R₃SiO_{1/2}] (III),

[R₂SiO_{2/2}] (IV),

[RSiO_{3/2}] (V),

[SiO_{4/2}] (VI),

where R is as defined above.

The organopolysiloxane (P) preferably comprises from 1 to 100.0 mol % of units of the general formula (I), from 0 to 50.0 mol % of units of the general formula (III), from 0 to 90.0 mol % of units of the general formula (IV), from 0 to 50.0 mol % of units of the general formula (V), and from 0 to 50.0 mol % of units of the general formula (VI).

In particular, the organopolysiloxane (P) comprises from 1 to 50.0 mol % of units of the general formula (I), from 0 to 40.0 mol % of units of the general formula (III), from 10 to 80.0 mol % of units of the general formula (IV), from 0 to 10.0 mol % of units of the general formula (V), from 0 to 10.0 mol % of units of the general formula (VI).

The organopolysiloxane (P) may be a linear or cyclic molecule, and the peroxy groups may be attached in a comb-like manner and/or to the chain end. The organopolysiloxane (P) may also be branched or crosslinked.

The organopolysiloxane (P) has a total of at least 2, in particular at least 3, units of the general formulae (I) and (III) to (VI). It may be liquid or solid at 25° C. The viscosity at 25° C. is preferably not more than 100 Pas, more preferably not more than 10 Pas, and in particular, not more than 2 Pas.

The peroxide-functional organopolysiloxane (P) which has at least one unit of the above general formula (I) may be prepared by reacting organopolysiloxane (A) which has at least one unit of the general formula (VII)

ZₐR_{b}SiO_{4-a-b/2} (VII)

where Z is a group of the general formula (VIII)

-A-CR″₂—OH (VIII)

and/or where Z is a group of the general formula (IX)

-A-CR″═CH₂ (IX)

where R, R″, a and b are each as defined above, with H₂O₂, resulting in an organopolysiloxane (P) where R′″ is a hydrogen atom.

The organopolysiloxane of the general formula (VII) which contains the radical of the general formula (VIII) may be prepared, for example, by transition metal-catalyzed reaction of unsaturated tertiary alcohols with polysiloxanes containing Si—H bonds (hydrosilylation), for example 2-methyl-3-buten-2-ol, 2-hydroxy-2,5-dimethyl-5-hexene or H₂C═CMe-Ph-CMe₂OH.

The organopolysiloxane of the general formula (VII) containing the radical of the general formula (IX) can be prepared, for example, by transition metal-catalyzed reaction of a sufficient excess of diunsaturated compounds containing 2-propenyl groups with polysiloxanes containing Si—H bonds (hydrosilylation), for example 2,5-dimethyl-1,5-hexadiene or H₂C=CMe-Ph-CMe═CH₂, so that on average only one of the double bonds is consumed in the reaction.

The organopolysiloxane of the general formula (VII) containing the radical of the general formula (IX) can likewise be prepared by Si—C coupling reactions using organometallic reagents, for example by reaction of polysiloxane containing Si—Cl groups with Grignard reagents of the formula H₂C═CMe-MgCl or H₂C═CMe-CH₂MgCl or other organometallic coupling reagents.

To prepare the organopolysiloxanes (P) in which R′″ is a monovalent C₁- to C₁₈-hydrocarbon radical or C₁- to C₁₈-acyl radical which may be cyano-, fluorine-, chlorine-, bromine- or organopolysiloxane-substituted, and be interrupted by divalent radicals bonded on both sides to carbon atoms, and from the group of —O—, ‘COO—, —OOC—, —CONR—, —NR¹CO— and —CO—, organopolysiloxane (P) in which R′″ is a hydrogen atom is reacted with the compound of the general formula (X)

XR′″ (X)

where

R′″ is a monovalent C₁- to C₁₈-hydrocarbon radical or C₁- to C₁₈ -acyl radical which may be cyano-, fluorine-, chlorine-, bromine- or organopolysiloxane-substituted, optionally interrupted by divalent radicals which are bonded on both sides to carbon atoms, and from the group of —O—, —COO—, —OOC—, —CONR¹—, —NR¹CO— and —CO— and

X is fluorine, chlorine, bromine, hydroxyl, hydrogen or an acid anhydride radical.

When X is hydrogen, the reaction may be effected, for example, together with CuCl. When X is fluorine, chlorine or bromine, the reaction may be effected, for example, together with dicyclohexylcarbodiimide. When R′″ is an acyl radical and X is an acid anhydride radical, the reaction may be effected, for example, together with CuCl.

The reaction of organopolysiloxane (A) with H₂H₂ preferably takes place under acid catalysis. Preference is given to strong acids, such as sulfuric acid.

The reaction of organopolysiloxane (A) with H₂O₂ preferably occurs in a solution or dispersion of the organopolysiloxane (A). Preference is given to using alcohols or similar polar solvents. The reaction of organopolysiloxane (A) with H₂O₂ preferably occurs at a temperature of from 20 to 100° C.

Organopolysiloxane (A) is known per se. It may be prepared, for example, by addition of aliphatically unsaturated tertiary alcohols to organopolysiloxanes having Si—H groups.

All of the above symbols of the above formulae are each defined independently of one another.

In the examples which follow, in each case unless otherwise stated, all amounts and percentages are based on weight, all pressures are 0.10 MPa (abs.) and all temperatures are 20° C.

### EXAMPLE 1

In a stirred 2 liter three-neck flask equipped with a reflux condenser, 1000 grams of a polydimethylhydrosiloxane having terminal Si—H groups (active hydrogen content 0.055% by weight) were initially charged, and the flask was purged with nitrogen and heated to 90° C. 52.03 grams of 2-methyl-3-buten-2-ol which had been admixed beforehand with 0.5 gram of a 1.1% by weight platinum (IV)-containing catalyst solution (hexachloroplatinic acid in isopropanol, “Speier catalyst”) were subsequently metered in within 60 minutes via an attached dropping funnel. The metering was effected in such a way that the boiling point of the reaction mixture was not exceeded. After the end of the metered addition, another 0.2 g of the catalyst solution was added, and stirring was continued at 100° C. for 60 minutes. Excess methylbutenol was removed on a rotary evaporator at 100° C. and 5 mbar, and the product obtained was filtered through a pressure suction filter. The successful conversion to the corresponding hydrosilylation product is confirmed by 1H NMR.

### EXAMPLE 2

In a stirred 2 liter three-neck flask equipped with a reflux condenser, 1000 grams of a polydimethylhydrosiloxane having pendant Si—H groups (active hydrogen content 0.32% by weight) were initially charged, and the flask was purged with nitrogen and heated to 90° C. 309 grams of 2-methyl-3-buten-2-ol which had been admixed beforehand with 0.6 gram of a 1.1% by weight platinum (IV)-containing catalyst solution (hexachloroplatinic acid in isopropanol, “Speier catalyst”) were subsequently metered in within 60 minutes via an attached dropping funnel. The metering was effected in such a way that the boiling point of the reaction mixture was not exceeded. After the end of the metered addition, another 0.2 g of the catalyst solution was added, and stirring was continued at 100° C. for 60 minutes. Excess methylbutenol was removed on a rotary evaporator at 100° C. and 5 mbar, and the product obtained was filtered through a pressure suction filter. The successful conversion to the corresponding hydrosilylation product is confirmed by 1H NMR. The hydrosilylation product has a chain length of 30-40, 8-10 tertiary OH side groups and 4.15% by weight of OH.

### EXAMPLE 3

In a stirred 3 liter three-neck flask equipped with a reflux condenser, 500 grams of a tetramethyldisiloxane having pendant Si—H groups (active hydrogen content 1.5% by weight) were initially charged, and the flask was purged with nitrogen and heated to 90° C. 1370 grams of 2-methyl-3-buten-2-ol which had been admixed beforehand with 0.9 gram of a 1.1% by weight platinum (IV)-containing catalyst solution (hexachloroplatinic acid in isopropanol, “Speier catalyst”) were subsequently metered in within 120 minutes via an attached dropping funnel. The metering was effected in such a way that the boiling point of the reaction mixture was not exceeded. After the end of the metered addition, another 0.3 g of the catalyst solution was added, and stirring was continued at 100° C. for 60 minutes. Excess methylbutenol was removed on a rotary evaporator at 100° C. and 5 mbar, and the product obtained was filtered through a pressure suction filter. The successful conversion to the corresponding hydrosilylation product is confirmed by 1H NMR.

### EXAMPLE 4

In a stirred 2 liter three-neck flask equipped with a reflux condenser, 1000 grams of a polydimethylhydrosiloxane having terminal Si—H groups (active hydrogen content 0.17% by weight) were initially charged, and the flask was purged with nitrogen and heated to 90° C. 156.1 grams of 2-methyl-3-buten-2-ol which had been admixed beforehand with 0.5 gram of a 1.1% by weight platinum (IV)-containing catalyst solution (hexachloroplatinic acid in isopropanol, “Speier catalyst”) were subsequently metered in within 60 minutes via an attached dropping funnel. The metering was effected in such a way that the boiling point of the reaction mixture was not exceeded. After the end of the metered addition, another 0.2 g of the catalyst solution was added, and stirring was continued at 100° C. for 60 minutes. Excess methylbutenol was removed on a rotary evaporator at 100° C. and 5 mbar, and the product obtained was filtered through a pressure suction filter. The successful conversion to the corresponding hydrosilylation product is confirmed by 1H NMR. The hydrosilylation product has a chain length of 15 to 20, terminal and tertiary OH groups, 2.75 % by weight of OH.

### EXAMPLE 5

A polysiloxane hydroperoxide is prepared from the polysiloxane polyol prepared according to example 2 using alcoholic solvent:

Raw materials:

| | |
|---|---|
| 70% H₂O₂ | 300 g |
| 72% H₂SO₄ | 200 g |
| Turpinal ® SL | 5 ml (complexing agent based on phosphoric |
| | acid) |
| Silicone copolyol | 500 g (approx. 1.22 mol of OH groups) |
| according to example 2 | |
| Ethanol | 125 g |

Process:

H₂O₂, H₂SO₄ and Turpinal® are initially charged at approx. 25° C. The silicone copolyol/ethanol mixture is added dropwise at approx. 30° C. within about 30 minutes. The mixture is heated to 35° C. and stirred for 30 minutes, then heated to 50° C. and stirred for a further 45 minutes. After cooling to 25° C., 500 g of 5% (NH₄)₂SO₄ solution are added, and the mixture is stirred for 5 minutes and then separated for 40 minutes. (712 g of a slightly cloudy, aqueous phase). The organic phase is washed four times more with 500 g each time of 10% (NH₄)₂SO₄ solution, separating time in each case 45 minutes, aqueous phases clear. The organic phase is allowed to stand until the next day and the aqueous phase is again removed. Product: 520 g of viscous, cloudy liquid; active oxygen content: 3.01%, corresponding to 6.2% by weight of OOH groups, approximately 80% conversion of the OH groups.

### EXAMPLE 6

A polysiloxane hydroperoxide is prepared from the polysiloxane polyol prepared according to example 4, without solvent:

| Raw materials: | |
|---|---|
| 70% H₂O₂ | 240 g |
| 72% H₂SO₄ | 160 g |
| Turpinal ® SL | 2 ml |
| Silicone copolyol | 370 g (approx. 0.6 mol of OH groups) |

Process:

H₂O₂, H₂SO₄ and Turpinal® are initially charged at approx. 25° C. The silicone copolyol is added dropwise at approx. 30° C. within from 30 to 40 minutes. The mixture is then heated to 35° C. and stirred for 90 minutes, then heated to 50° C. and stirred for a further 30 minutes. After cooling to 25° C., the phases are separated for 30 minutes (375 g of clear, aqueous phase). The organic phase is washed three times with 300 ml each time of 5% (NH₄)₂SO₄ solution (separating time in each case 30 minutes, aqueous phases clear, organic phase cloudy). Together with 30 g of anhydrous Na₂SO₄, the mixture is stirred for 30 minutes and filtered. Product: 358 g of clear, colorless, slightly viscous liquid; active oxygen content: 2.52% (corresponding to 5.2% by weight of OOH groups, approx. 100% conversion of the OH groups).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A peroxide-functional organopolysiloxane (P) which comprises at least one unit of the formula (I)
YₐR_{b}SiO_{4-a-b/2} (I)
where
Y is a group of the formula (II)
-A-CR″₂—OO—R′″ (II),
R is a hydrogen atom, a C₁- to C₁₂-alkoxy radical, a hydroxy radical, an alkyl glycol radical, or a monovalent, optionally cyano-, fluorine-, chlorine- or bromine-substituted C₁- to C₁₈-hydrocarbon radical optionally interrupted by divalent radicals bonded on both sides to carbon atoms, selected from the group consisting of —O—, —COO—, —OOC—, —CONR′—, —NR¹CO— and —CO—,
A is a chemical bond or a divalent, optionally cyano-, fluorine-, chlorine- or bromine-substituted C₁- to C₁₈-hydrocarbon radical,
R″ is an optionally cyano-, fluorine-, chlorine- or bromine-substituted C₁- to C₁₀-hydrocarbon radical,
R′″ is a monovalent C₁- to C₁₈-hydrocarbon radical or C₁- to C₁₈-acyl radical each optionally cyano-, fluorine-, chlorine-, bromine- or organopolysiloxane-substituted and optionally interrupted by divalent radicals bonded on both sides to carbon atoms, selected from the group consisting of —O—, —COO—, —OOC—, —CONR′—, —NR¹CO— and —CO—,
R¹ is a hydrogen atom or an R″ radical,
a is 1, 2 or 3,
b is 0, 1 or 2, and
the sum of a+b is 1, 2or 3.

2. The peroxide-functional organopolysiloxane (P) of claim 1, wherein R is an unsubstituted or substituted C₁ to C₁₈-alkyl radical, hydrogen, or phenyl radical.

3. The peroxide-functional organopolysiloxane (P) of claim 1, wherein R′″ is hydrogen or an unsubstituted or substituted C₁- to C₁₈-alkyl radical.

4. The peroxide-functional organopolysiloxane (P) of claim 2, wherein R′″ is hydrogen or an unsubstituted or substituted C₁- to C₁₈-alkyl radical.

5. The peroxide-functional organopolysiloxane (P) of claim 1, wherein R″ is an optionally substituted C₁- to C₆-alkyl radical.

6. The peroxide-functional organopolysiloxane (P) of claim 1, wherein A is a linear C₁- to C₆-alkylene radical.

7. The peroxide-functional organopolysiloxane (P) of claim 1, which, in addition to the units of the general formula (I), contains siloxane units of the formulae (III), (IV), (V) and (VI)
[R₃SiO_{1/2}] (III),
[R₂SiO_{2/2}] (IV),
[RSiO_{3/2}] (V),
[SiO_{4/2}] (VI),
where R is a hydrogen atom, a C₁- to C₁₂-alkoxy radical, a hydroxy radical, an alkyl glycol radical, or a monovalent, optionally cyano-, fluorine-, chlorine- or bromine-substituted C₁- to C₁₈-hydrocarbon radical optionally interrupted by divalent radicals bonded on both sides to carbon atoms, selected from the group consisting of —O—, —COO—, —OOC—, —CONR′—, —N¹CO— and —CO—,

8. A process for the preparation of a modified organopolysiloxane, comprising reacting an organopolysiloxane (M) with the peroxide-functional organopolysiloxane (P) of claim 1.

9. The process of claim 8, wherein said organopolysiloxane (M) comprises a free-radically crosslinkable silicone rubber, said process comprising free-radically crosslinking said crosslinkable silicone rubber employing said organopolysiloxane (P).

10. The process of claim 8, wherein the organopolysiloxane (P) is used as a free radical initiator in the synthesis of silicone block and graft copolymers by polymerizing monomers polymerizable by free radicals.

11. A process for the preparation of the organosiloxane (P) of claim 1, comprising reacting an organopolysiloxane (A) of the formula VII
ZₐR_{b}SiO_{4-a-b/2} (VII)
where Z is a group of the general formula (VIII)
-A-CR″₂—OH (VIII)
and/or where Z is a group of the general formula (IX)
-A-CR″═CH₂ (IX)
where R, R″, a and b are each as defined above, with H₂O₂, resulting in an organopolysiloxane (P) where R′″ is a hydrogen atom.

12. The process of claim 11, wherein said reacting takes place in the presence of a strong acid.

13. The process of claim 11 which takes place in polar organic solvent.

14. The process of claim 11, wherein said polar organic solvent comprises an alcohol.
